(19) United States
(12) Patent Application Publication
(10) Pub. No.: US 2026/0121526 A1
(43) Pub. Date: Apr. 30, 2026

(54) Integrated Circuit Device

(71) Applicant: SEIKO EPSON CORPORATION, Tokyo (JP)

(72) Inventor: Shinichi SEKITA, Suwa (JP)

(21) Appl. No.: 19/338,348

(22) Filed: Sep. 24, 2025

(30) Foreign Application Priority Data
Sep. 25, 2024 (JP) 2024-166013

(51) Int. Cl. H02M 3/00; H02M 3/07

(52) U.S. Cl. CPC H02M 3/003; H02M 3/07

(57) ABSTRACT

An integrated circuit device includes: a first pad and a second pad coupled to a capacitor; and a transistor portion configured to perform charge and discharge control of the capacitor via the first pad and the second pad. The transistor portion includes a first portion and a second portion disposed with the first pad and the second pad sandwiched therebetween in a plan view.

The present application is based on, and claims priority from JP Application Ser. Number 2024-166013, filed Sep. 25, 2024, the disclosure of which is hereby incorporated by reference herein in its entirety.

### BACKGROUND

### 1. Technical Field

The present disclosure relates to an integrated circuit device.

### 2. Related Art

JP-A-2010-213368 discloses a DC-DC converter that operates intermittently, the DC-DC converter being provided with a switching unit capable of making each of a plurality of capacitors electrically independent in order to prevent a charge outflow from the capacitors when the DC-DC converter is not operating.

JP-A-2010-213368 is an example of the related art.

In a charge pump operation for charging and discharging a capacitor, when a wiring resistance is large, a charging voltage to the capacitor may be reduced due to a voltage drop, but the DC-DC converter described in JP-A-2010-213368 does not consider the problem.

### SUMMARY

An aspect of an integrated circuit device according to the present disclosure includes:
a first pad and a second pad coupled to a capacitor; and
a transistor portion configured to perform charge and discharge control of the capacitor via the first pad and the second pad.

The transistor portion includes a first portion and a second portion disposed with the first pad and the second pad sandwiched therebetween in a plan view.

### BRIEF DESCRIPTION OF THE DRAWINGS

FIG. 1 is an external perspective view of a multifunction machine.

FIG. 2 is a perspective view showing an internal structure of a scanner unit.

FIG. 3 is an exploded perspective view schematically showing a configuration of an image sensor module.

FIG. 4 is a plan view schematically showing an arrangement of an image reading chip.

FIG. 5 is a diagram showing a functional configuration of the scanner unit.

FIG. 6 is a functional block diagram showing a configuration of an integrated circuit device according to the embodiment.

FIG. 7 is a diagram showing a configuration example of a switching circuit.

FIG. 8 is a diagram showing an equivalent circuit of the switching circuit in a charging state of a capacitor.

FIG. 9 is a diagram showing an equivalent circuit of the switching circuit in a discharge state of the capacitor.

FIG. 10 is a diagram showing a layout configuration of the integrated circuit device.

FIG. 11 is a diagram showing a layout configuration of the switching circuit and an electrostatic protection circuit according to the embodiment.

FIG. 12 is a diagram showing a circuit configuration of a PMOS transistor.

FIG. 13 is a diagram showing a layout configuration of the PMOS transistor.

FIG. 14 is a diagram showing a layout configuration of a switching circuit and an electrostatic protection circuit in a comparative example.

### DESCRIPTION OF EMBODIMENTS

Hereinafter, a preferred embodiment of the present disclosure will be described in detail with reference to the drawings. The drawings to be used are for the sake of convenience of description. Note that the embodiment described below do not unreasonably limit the content of the present disclosure set forth in the appended claims. Not all of components explained below are always essential elements of the present disclosure.

An integrated circuit device according to the present disclosure can be used in various electronic devices. Hereinafter, an integrated circuit device to be used as an analog front end in a scanner unit will be described using a multifunction machine including a printer unit and the scanner unit as an example.

### 1. Structure of Multifunction Machine

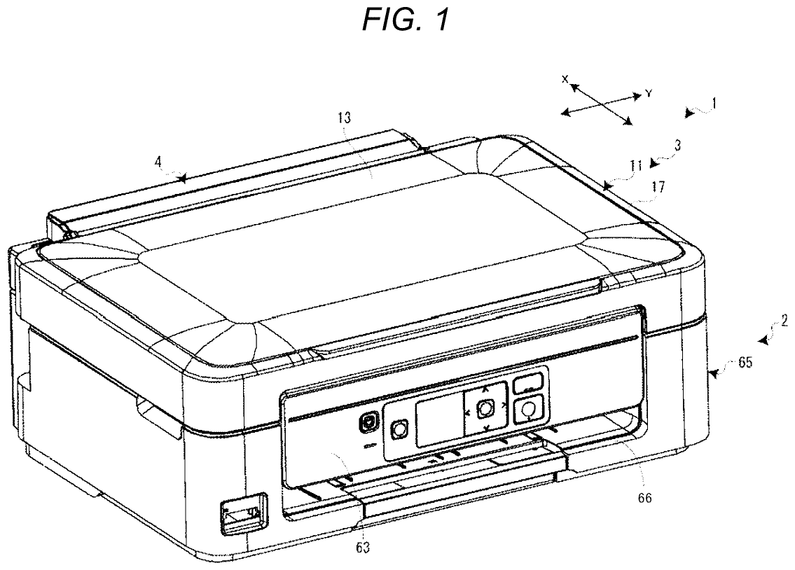

FIG. 1 is an external perspective view of a multifunction machine 1. As shown in FIG. 1, the multifunction machine 1 includes a printer unit 2 that is an image recording device and a scanner unit 3 that is an image reading device. Specifically, the multifunction machine 1 integrally includes the printer unit 2, which is a machine body, and the scanner unit 3, which is an upper unit provided at an upper portion of the printer unit 2. Hereinafter, description will be made by setting a front-rear direction as an X-axis direction and a left-right direction as a Y-axis direction, in FIG. 1.

As shown in FIG. 1, the printer unit 2 includes a transport unit (not shown) which feeds a recording medium such as print paper or cut paper along a feeding path, a print unit (not shown) which is disposed on an upper portion of the feeding path and performs print processing on the recording medium by using an inkjet method, an operation unit 63 of a panel type which is disposed on a front surface, a device frame (not shown) in which the transport unit, the print unit and the operation unit 63 are mounted, and a device housing 65 which covers these components. The device housing 65 is provided with a discharge port 66 from which a printed recording medium is discharged. Although not shown in the drawings, a USB port and a power supply port are disposed in a lower portion of a rear surface of the printer unit 2. That is, the multifunction machine 1 can be connected to a computer or the like via the USB port.

The scanner unit 3 is pivotably supported by the printer unit 2 via a hinge portion 4 at a rear end portion, and covers an upper portion of the printer unit 2 in an openable and closable manner. That is, by pulling up the scanner unit 3 in a pivoting direction, an upper opening portion of the printer unit 2 is exposed, and an interior of the printer unit 2 is exposed via the upper opening portion. On the other hand, the upper opening portion is closed with the scanner unit 3 by pulling down the scanner unit 3 in the pivoting direction and placing the scanner unit 3 on the printer unit 2. Therefore, for example, ink cartridges can be replaced and a paper jam can be resolved by opening the scanner unit 3.

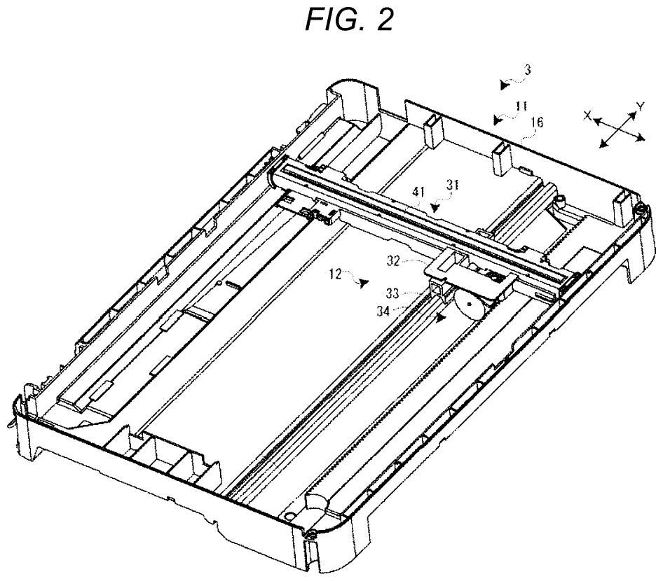

FIG. 2 is a perspective view showing an internal structure of the scanner unit 3. As shown in FIGS. 1 and 2, the scanner unit 3 includes an upper frame 11 which is a housing, an image reading unit 12 accommodated in the upper frame 11, an upper lid 13 pivotably supported to an upper portion of the upper frame 11. As shown in FIG. 2, the upper frame 11 includes a box-shaped lower case 16 which accommodates the image reading unit 12, and an upper case 17 which covers a top surface of the lower case 16. A document placing plate (not shown) made of glass is widely disposed in the upper case 17, and a medium to be read with a surface to be read facing down is placed thereon. Meanwhile, the lower case 16 is formed to have a shallow box shape that is open in its upper surface.

As shown in FIG. 2, the image reading unit 12 includes a sensor unit 31 of a line sensor type, a sensor carriage 32 on which the sensor unit 31 is mounted, a guide shaft 33 which extend in the Y-axis direction and slidably supports the sensor carriage 32, and a self-propelled sensor moving mechanism 34 which moves the sensor carriage 32 along the guide shaft 33. The sensor unit 31 includes an image sensor module 41 which is a CMOS line sensor extending in the X-axis direction, and reciprocates in the Y-axis direction along the guide shaft 33 by the motor-driven sensor moving mechanism 34. Here, the CMOS is an abbreviation for complementary metal-oxide-semiconductor. Accordingly, an image of the medium to be read on the document placing plate is read. The sensor unit 31 may be a CCD line sensor. CCD is an abbreviation for charge coupled device.

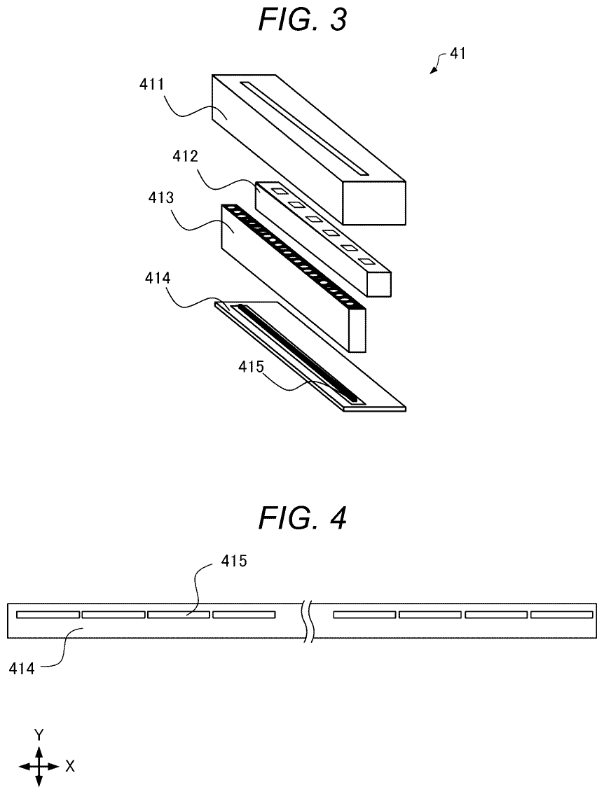

FIG. 3 is an exploded perspective view schematically showing a configuration of the image sensor module 41. In the example shown in FIG. 3, the image sensor module 41 includes a case 411, a light source 412, a lens 413, a module substrate 414, and image reading chips 415 each being a semiconductor device for reading an image. The light source 412, the lens 413, and the image reading chips 415 are accommodated between the case 411 and the module substrate 414. The case 411 is provided with a slit. The light source 412 includes, for example, light emitting diodes of R, G, and B, and causes the light emitting diodes of R, G, and B, that is, a red LED, a green LED, and a blue LED, to emit light in order or to emit light at the same time according to a use situation of a user. That is, the light source 412 causes the red LED, the green LED, and the blue LED to sequentially emit light in the case of color scanning, and causes the red LED, the green LED, and the blue LED to simultaneously emit light in the case of monochrome scanning. LED is an abbreviation for light emitting diode. The light source 412 irradiates the medium to be read with light through the slit, and the light from the medium to be read is input to the lens 413 through the slit. The lens 413 guides the input light to the image reading chip 415. Then, the image reading chip 415 reads the image formed at the medium to be read based on the light emitted from the light source 412 and reflected by the medium to be read.

FIG. 4 is a plan view schematically showing the arrangement of the image reading chips 415. As shown in FIG. 4, a plurality of the image reading chips 415 are arranged on the module substrate 414 in a one-dimensional direction, specifically, in the X-axis direction. Each of the image reading chips 415 includes a plurality of light receiving elements which are arranged in a row, and the higher density of the light receiving elements provided in each of the image reading chips 415 is, the scanner unit 3 with the higher resolution for reading an image can be implemented. As the number of image reading chips 415 increases, the scanner unit 3 capable of reading a larger image can be implemented.

### 2. Functional Configuration of Scanner Unit

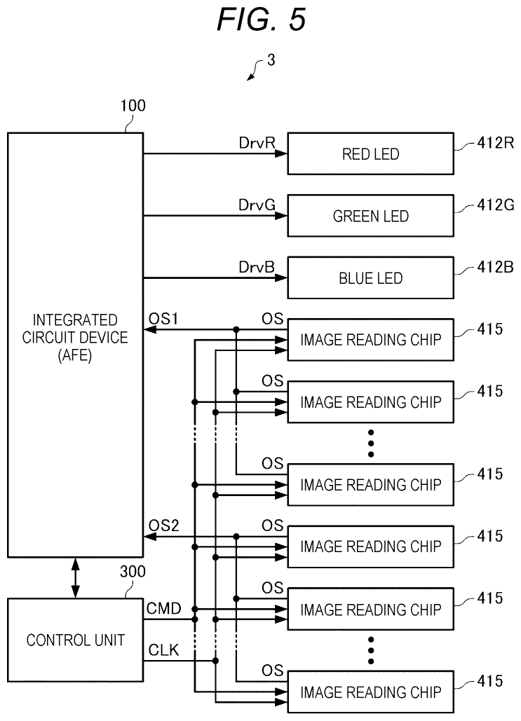

FIG. 5 is a functional block diagram showing a functional configuration of the scanner unit 3 which is an image reading device. In the example shown in FIG. 5, the scanner unit 3 includes an integrated circuit device 100 functioning as an analog front end, a control unit 300, a red LED 412R, a green LED 412G, a blue LED 412B, and the plurality of image reading chips 415. As described above, the red LED 412R, the green LED 412G, and the blue LED 412B are provided in the light source 412, and the plurality of image reading chips 415 are arranged side by side on the module substrate 414. A plurality of red LED 412Rs, green LED 412Gs, and blue LED 412Bs may be present. The integrated circuit device 100 and the control unit 300 are provided on the module substrate 414 or a substrate (not shown) different from the module substrate 414. The control unit 300 may be implemented by an integrated circuit.

The integrated circuit device 100 supplies a drive signal DrvR to the red LED 412R for a certain exposure time At at a predetermined timing to cause the red LED 412R to emit light. Similarly, the integrated circuit device 100 supplies a drive signal DrvG to the green LED 412G for the exposure time At at a predetermined timing to cause the green LED 412G to emit light, and supplies a drive signal DrvB to the blue LED 412B for the exposure time Δt at a predetermined timing to cause the blue LED 412B to emit light. The integrated circuit device 100 emits the red LED 412R, the green LED 412G, and the blue LED 412B one by one.

The control unit 300 supplies a clock signal CLK and a command signal CMD to the plurality of image reading chips 415. The clock signal CLK is an operation clock signal of the image reading chip 415, and the command signal CMD is a signal including various commands such as a command for setting a resolution of image reading by the scanner unit 3 and a command for instructing start and end of image reading.

Each of the image reading chips 415 operates in synchronization with the clock signal CLK, and generates and outputs an image signal OS having image information of a set resolution based on light received by each light receiving element from an image formed at a medium to be read by light emission of the red LED 412R, the green LED 412G, or the blue LED 412B.

The integrated circuit device 100 receives the image signal OS output by each of the image reading chips 415 as one of two-channel image signals OS1 and OS2, performs amplification processing and A/D conversion processing on each image signal OS to convert the image signal OS into a digital signal including a digital value corresponding to an amount of light received by each light receiving element, and sequentially transmits each digital signal to the control unit 300.

The control unit 300 receives each digital signal sequentially transmitted from the integrated circuit device 100 and generates image information read by the image sensor module 41.

### 3. Functional Configuration of Integrated Circuit Device

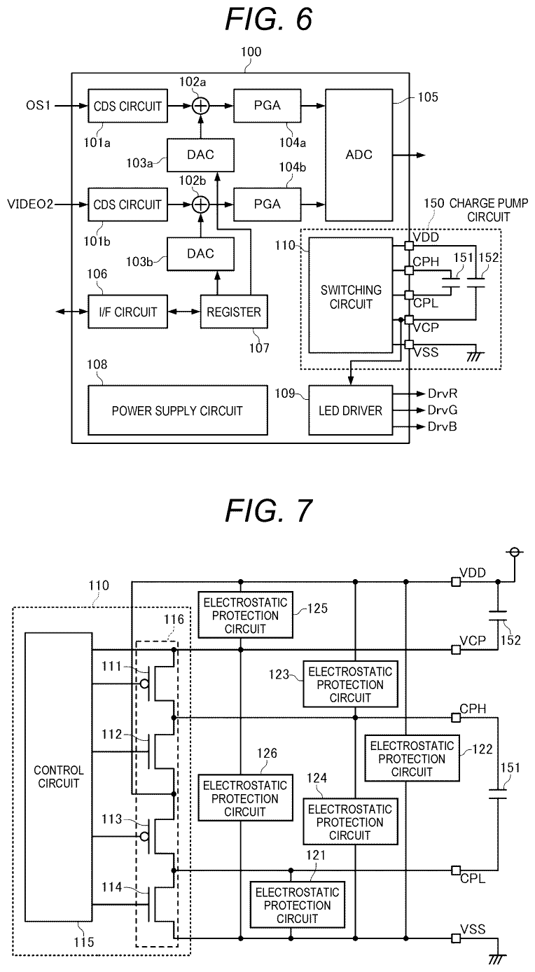

FIG. 6 is a functional block diagram showing a configuration of the integrated circuit device 100 according to the embodiment. As shown in FIG. 6, the integrated circuit device 100 includes CDS circuits 101a and 101b, adders 102a and 102b, D/A converters 103a and 103b, programmable gain amplifiers 104a and 104b, an A/D conversion circuit 105, an interface circuit 106, a register 107, a power supply circuit 108, an LED driver 109, and a switching circuit 110. CDS is an abbreviation for correlated double sampling.

The power supply circuit 108 is a circuit that generates a power supply voltage of each unit of the integrated circuit device 100.

The image signal OS1 of a first channel is input to the CDS circuit 101a. The CDS circuit 101a removes noise included in the image signal OS1 by correlated double sampling, and outputs a voltage signal corresponding to light received by each light receiving element included in the image reading chip 415.

The adder 102a outputs a signal obtained by adding the signal output from the CDS circuit 101a and the signal output from the D/A converter 103a. An offset correction value stored in the register 107 is input to the D/A converter 103a, and an analog signal having a voltage for offset correction is output. Therefore, the adder 102a outputs a signal from which an offset voltage included in the signal output from the CDS circuit 101a is removed.

The programmable gain amplifier 104a outputs a signal obtained by amplifying the signal output from the adder 102a with a preset gain.

As described above, the CDS circuit 101a, the adder 102a, the D/A converter 103a, and the programmable gain amplifier 104a perform signal processing on the image signal OS1 of the first channel.

The image signal OS2 of a second channel is input to the CDS circuit 101b. The CDS circuit 101b removes noise included in the image signal OS2 by correlated double sampling, and outputs a voltage signal corresponding to light received by each light receiving element provided in the image reading chip 415.

The adder 102b outputs a signal obtained by adding the signal output from the CDS circuit 101b and the signal output from the D/A converter 103b. An offset correction value stored in the register 107 is input to the D/A converter 103b, and an analog signal having a voltage for offset correction is output. Therefore, the adder 102b outputs a signal from which an offset voltage included in the signal output from the CDS circuit 101b is removed.

The programmable gain amplifier 104b outputs a signal obtained by amplifying the signal output from the adder 102b with a preset gain.

As described above, the CDS circuit 101b, the adder 102b, the D/A converter 103b, and the programmable gain amplifier 104b perform signal processing on the image signal OS2 of the second channel.

The A/D conversion circuit 105 time-divisionally converts the analog signal output from the programmable gain amplifier 104a and the analog signal output from the programmable gain amplifier 104b into digital signals. The A/D conversion circuit 105 outputs the converted digital signal to the control unit 300.

The interface circuit 106 is a circuit that performs data communication with the control unit 300, and writes and reads various types of data to and from the register 107 in response to a request from the control unit 300. The register 107 stores various types of data such as the offset correction value described above.

The LED driver 109 generates the drive signals DrvR, DrvG, and DrvB based on the drive voltage output from the switching circuit 110, and outputs the drive signals DrvR, DrvG, and DrvB to the red LED 412R, the green LED 412G, and the blue LED 412B, respectively.

The switching circuit 110 is coupled to a VDD terminal, a CPH terminal, a CPL terminal, a VCP terminal, and a VSS terminal of the integrated circuit device 100. The VDD terminal and the VCP terminal are coupled to both ends of an external capacitor 151 of the integrated circuit device 100, and the CPH terminal and the CPL terminal are coupled to both ends of an external capacitor 152 of the integrated circuit device 100.

The switching circuit 110 and the capacitors 151 and 152 constitute a charge pump circuit 150 and generate a voltage obtained by boosting a voltage of the VDD terminal at the VCP terminal. The voltage of the VCP terminal is supplied to the LED driver 109 as a drive voltage.

### 4. Configuration of Switching Circuit

FIG. 7 is a diagram showing a configuration example of the switching circuit 110. FIG. 7 also shows electrostatic protection circuits 121 to 126 and the capacitors 151 and 152 coupled to the switching circuit 110.

As shown in FIG. 7, the switching circuit 110 includes a control circuit 115 and a transistor portion 116. The transistor portion 116 includes a PMOS transistor 111, a NMOS transistor 112, a PMOS transistor 113, and a NMOS transistor 114.

The PMOS transistor 111 has a source coupled to the CPH terminal and a drain coupled to the VCP terminal. The NMOS transistor 112 has a source coupled to the CPH terminal and a drain coupled to the VDD terminal. The PMOS transistor 113 has a source coupled to the VDD terminal and a drain coupled to the CPL terminal. The NMOS transistor 114 has a source coupled to the VSS terminal and a drain coupled to the CPL terminal.

The control circuit 115 outputs a control signal to each gate of the PMOS transistor 111, the NMOS transistor 112, the PMOS transistor 113, and the NMOS transistor 114, and controls the capacitor 151 to be in either a charging state or a discharge state.

The transistor portion 116 implemented as described above controls charge and discharge of the capacitor 151 via the VDD terminal, the CPH terminal, the CPL terminal, the VCP terminal, and the VSS terminal.

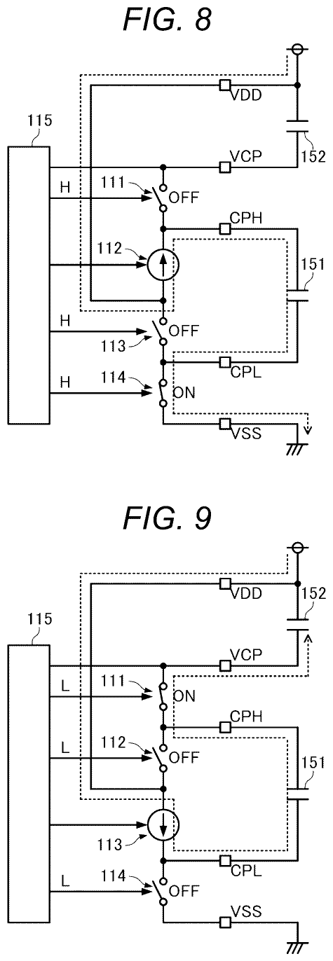

FIG. 8 is a diagram showing an equivalent circuit of the switching circuit 110 when the capacitor 151 is controlled to be in the charging state. As shown in FIG. 8, in the charging state of the capacitor 151, the PMOS transistors 111 and 113 and the NMOS transistor 114 function as switch elements, and the NMOS transistor 112 functions as a current source. Further, the control circuit 115 outputs an H-level control signal to each gate of the PMOS transistors 111 and 113 and the NMOS transistor 114, and outputs a control signal of a voltage corresponding to the voltage of the VCP terminal to the gate of the NMOS transistor 112. Accordingly, the PMOS transistors 111 and 113 enter a non-conductive state, the NMOS transistor 114 enters a conductive state, and a desired current flows between the drain and the source of the NMOS transistor 112. As a result, as indicated by a broken line in FIG. 8, a desired current flows from a power supply to the ground, and charges are accumulated in the capacitor 151.

FIG. 9 is a diagram showing an equivalent circuit of the switching circuit 110 when the capacitor 151 is controlled to the discharge state. As shown in FIG. 9, in the discharge state of the capacitor 151, the PMOS transistor 111 and the NMOS transistors 112 and 114 function as switch elements, and the PMOS transistor 113 functions as a current source. The control circuit 115 outputs an L-level control signal to each gate of the PMOS transistor 111 and the NMOS transistors 112 and 114, and outputs a control signal of a voltage corresponding to the voltage of the VCP terminal to the gate of the PMOS transistor 113. Accordingly, the NMOS transistors 112 and 114 enter a non-conductive state, the PMOS transistor 111 enters a conductive state, and a desired current flows between the source and the drain of the PMOS transistor 113. As a result, as indicated by a broken line in FIG. 9, a desired current flows from the power supply to the capacitor 152 via the capacitor 151, and the charges accumulated in the capacitor 151 are discharged and accumulated in the capacitor 152.

In this way, by the capacitor 151 repeating the charging state and the discharge state, a desired charge is accumulated in the capacitor 152, and the voltage of the VCP terminal increases to a desired voltage.

Returning to the description of FIG. 7, the electrostatic protection circuits 121 to 126 are provided inside the integrated circuit device 100. The electrostatic protection circuit 121 is coupled between the CPL terminal and the VSS terminal. The electrostatic protection circuit 122 is coupled between the VDD terminal and the VSS terminal. The electrostatic protection circuit 123 is coupled between the VDD terminal and the CPH terminal. The electrostatic protection circuit 124 is coupled between the CPH terminal and the VSS terminal. The electrostatic protection circuit 125 is coupled between the VDD terminal and the VCP terminal. The electrostatic protection circuit 126 is coupled between the VCP terminal and the VSS terminal.

### 5. Layout Configuration of Integrated Circuit Device

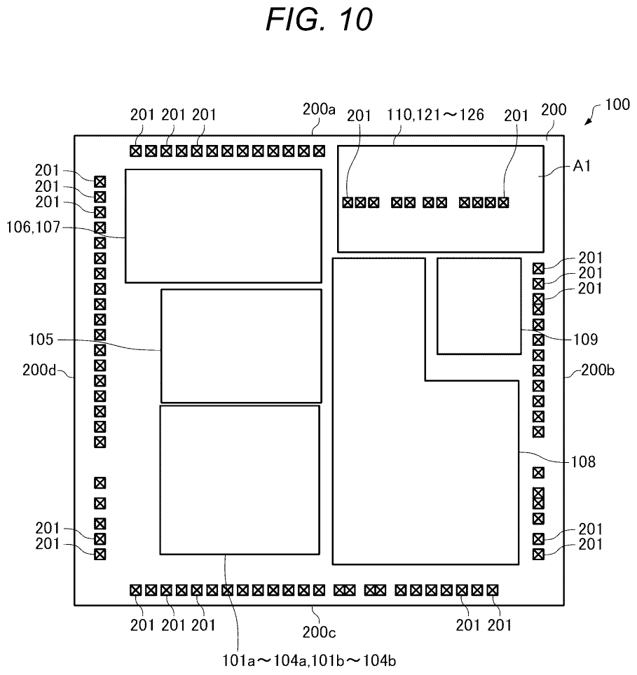

FIG. 10 is a diagram showing a layout configuration of the integrated circuit device 100. As shown in FIG. 10, the integrated circuit device 100 includes a semiconductor substrate 200. The semiconductor substrate 200 has a rectangular shape in a plan view, and has a side 200a, a side 200b intersecting the side 200a, a side 200c opposite to the side 200a, and a side 200d opposite to the side 200b. Contours of the integrated circuit device 100 and the semiconductor substrate 200 substantially coincide with each other in a plan view. Therefore, it can be said that the integrated circuit device 100 has a rectangular shape in a plan view and has the sides 200a, 200b, 200c, and 200d.

A large number of pads 201 are disposed on the semiconductor substrate 200 along the sides 200a, 200b, 200c, and 200d.

The power supply circuit 108 is disposed at a corner close to a point where the side 200b and the side 200c intersect. The LED driver 109 is disposed between the switching circuit 110 and the electrostatic protection circuits 121 to 126, and the power supply circuit 108.

The CDS circuits 101a and 101b, the adders 102a and 102b, the D/A converters 103a and 103b, and the programmable gain amplifiers 104a and 104b are disposed at corners close to a point where the side 200c and the side 200d intersect. Logic circuits such as the interface circuit 106 and the register 107 are disposed at corners close to a point where the side 200a and the side 200d intersect. The A/D conversion circuit 105 is disposed between the logic circuit and the CDS circuits 101a and 101b, the adders 102a and 102b, the D/A converters 103a and 103b, and the programmable gain amplifiers 104a and 104b.

The switching circuit 110 and the electrostatic protection circuits 121 to 126 are disposed at a corner close to a point where the side 200a and the side 200b intersect. Further, in a region A1 in which the switching circuit 110 and the electrostatic protection circuits 121 to 126 are disposed, the plurality of pads 201 are disposed in a region away from the sides 200a and 200b.

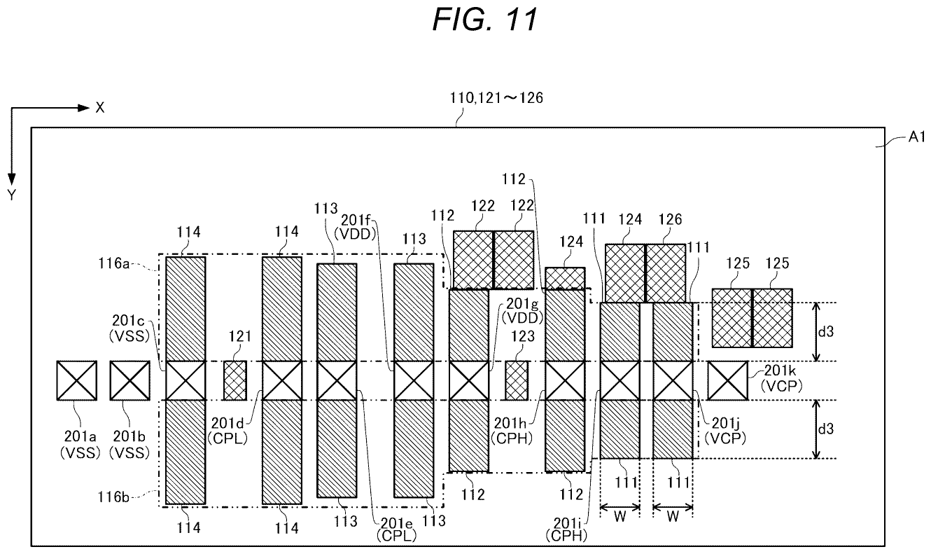

FIG. 11 is a diagram showing a layout configuration of the switching circuit 110 and the electrostatic protection circuits 121 to 126. In FIG. 11, illustration of the control circuit 115 and wiring are omitted. As shown in FIG. 11, in the region A1, eleven pads 201a to 201k are arranged in a row along the X direction. The pads 201a to 201k correspond to the eleven pads 201 arranged in the region A1 in FIG. 10.

The pads 201a, 201b, and 201c correspond to the VSS terminals shown in FIG. 6, and are coupled to each other by wiring (not shown). The pads 201d and 201e correspond to the CPL terminals shown in FIG. 6 and are coupled to each other by wiring (not shown). The pads 201f and 201g correspond to the VDD terminals shown in FIG. 6 and are coupled to each other by wiring (not shown). The pads 201h and 201i correspond to the CPH terminals shown in FIG. 6, respectively, and are coupled to each other by wiring (not shown). The pads 201j and 201k correspond to the VCP terminals shown in FIG. 6 and are coupled to each other by wiring (not shown).

The NMOS transistor 114 is divided into four and is disposed to sandwich the pads 201c and 201d in the Y direction. The PMOS transistor 113 is divided into four and is disposed to sandwich the pads 201e and 201f in the Y direction. The NMOS transistor 112 is divided into four and is disposed to sandwich the pads 201g and 201h in the Y direction. In addition, the PMOS transistor 111 is divided into four and is disposed to sandwich the pads 201i and 201j in the Y direction.

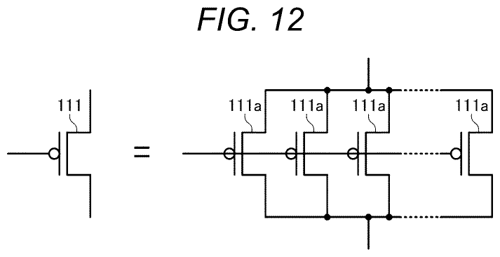

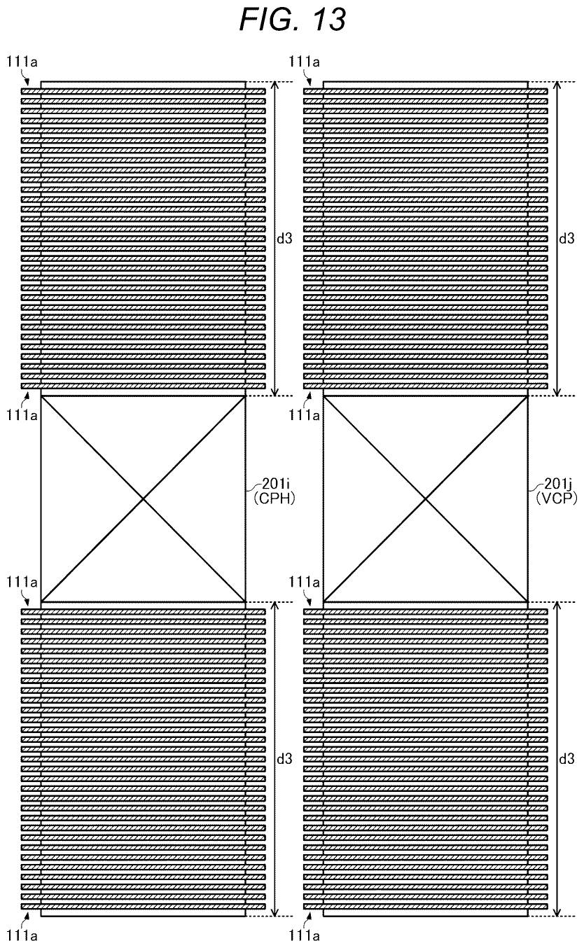

Specifically, as shown in FIG. 12, the PMOS transistor 111 is implemented by coupling a plurality of PMOS transistors 111a in parallel, and as shown in FIG. 13, the plurality of PMOS transistors 111a are divided into four and are disposed to sandwich the pads 201i and 201j in the Y direction. Although not shown, the configurations and layouts of the NMOS transistor 112, the PMOS transistor 113, and the NMOS transistor 114 are the same as those of the PMOS transistor 111.

As shown in FIG. 11, in a plan view of the semiconductor substrate 200, the transistor portion 116 includes a first portion 116a and a second portion 116b disposed with the pads 201c to 201j interposed therebetween. For example, the first portion 116a includes half of the plurality of PMOS transistors 111a coupled in parallel to each other constituting the PMOS transistor 111. Similarly, the first portion 116a includes half of the plurality of NMOS transistors coupled in parallel to each other constituting the NMOS transistor 112. Similarly, the first portion 116a includes half of the plurality of PMOS transistors coupled in parallel to each other constituting the PMOS transistor 113. Similarly, the first portion 116a includes half of the plurality of NMOS transistors coupled in parallel to each other constituting the NMOS transistor 114.

The first portion 116a and the second portion 116b of the transistor portion 116 are disposed along the Y direction, and the pads 201c to 201j are disposed along the X direction intersecting the Y direction. For example, the X direction and the Y direction are orthogonal to each other.

As shown in FIG. 11, the electrostatic protection circuit 121 is disposed between the pad 201c and the pad 201d, and is coupled to the pads 201a, 201b, and 201c and the pad 201d by wiring (not shown). The electrostatic protection circuit 123 is disposed between the pad 201g and the pad 201h, and is coupled to the pads 201f and 201g and the pads 201h and 201i by wiring (not shown). The electrostatic protection circuit 125 is disposed in the vicinity of the pad 201k and is coupled to the pads 201f and 201g and the pads 201j and 201k by wiring (not shown).

The electrostatic protection circuit 122 is disposed to sandwich a part of the NMOS transistor 112 with the pad 201g, and is coupled to the pads 201f and 201g and the pads 201a, 201b, and 201c by wiring (not shown). The electrostatic protection circuit 124 is disposed to sandwich a part of the NMOS transistor 112 with the pad 201h and to sandwich a part of the PMOS transistor 111 with the pad 201i, and is coupled to the pads 201h and 201i and the pads 201a, 201b, and 201c by wiring (not shown). The electrostatic protection circuit 126 is disposed to sandwich a part of the PMOS transistor 111 with the pad 201j, and is coupled to the pads 201j and 201k and the pads 201a, 201b, and 201c by wiring (not shown).

That is, as shown in FIG. 11, in a plan view of the semiconductor substrate 200, the first portion 116a of the transistor portion 116 is disposed between the pads 201g to 201j and the electrostatic protection circuits 122, 124, and 126. As described above, since the electrostatic protection circuits 122, 124, and 126 are disposed with a gap from the pads 201g to 201j, the first portion 116a and the second portion 116b of the transistor portion 116 are disposed adjacent to the pads 201c to 201j. Therefore, the shortest distance between the first portion 116a and the pads 201c to 201j is substantially zero, and the shortest distance between the second portion 116b and the pads 201c to 201j is also substantially zero.

The transistor portion 116 implemented in this manner performs charge and discharge control of the capacitor 151 via the pads 201a to 201k.

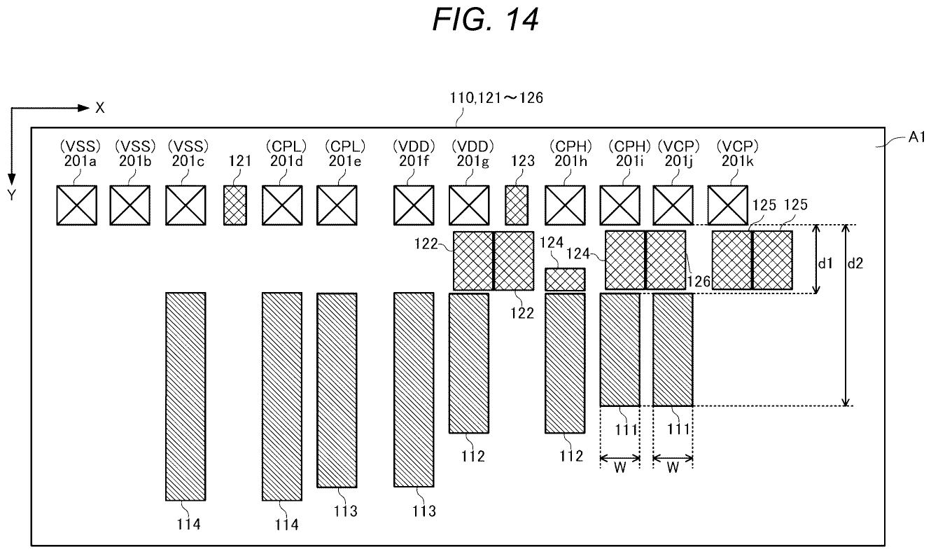

Here, in a general layout configuration, the pads 201a to 201k are disposed in a region close to the side 200a of the substrate semiconductor 200, and the electrostatic protection circuits 121 to 126 are disposed in the vicinity of the pads 201a to 201k. Therefore, as a comparative example of the embodiment, FIG. 14 shows a layout configuration of the switching circuit 110 and the electrostatic protection circuits 121 to 126 when the pads 201a to 201k are provided in a region close to the side 200a. In FIG. 14, illustration of the control circuit 115 and wiring are omitted.

In the layout configuration of the comparative example shown in FIG. 14, each of the plurality of PMOS transistors 111a provided in the PMOS transistor 111 is coupled to the pads 201i and 201j by wiring (not shown), and a distance in the Y direction between the pads 201i and 201j and the PMOS transistor 111a closest to the pads 201i and 201j, that is, the shortest distance is set to d1. In addition, in the Y direction, a distance from the pads 201i and 201j to the farthest PMOS transistor 111a, that is, the longest distance is set to d2.

In this case, since the PMOS transistor 111 is implemented by the plurality of PMOS transistors 111a, a resistance value R of the wiring that couples each of the pads 201i and 201j and the PMOS transistor 111 is substantially calculated by Formula (1) using the shortest distance d1 and the longest distance d2. In Formula (1), Rp is a sheet resistance value of a wiring, and W is a wiring width.

$$R = \frac{{R}_{p}}{2} ( \frac{d 1}{W} + \frac{d 2}{W} ) \qquad ( 1 )$$

A resistance value R of each wiring of the NMOS transistor 112, the PMOS transistor 113, and the NMOS transistor 114 is also calculated by Formula (1). When a current flows through these wirings, a voltage drop occurs, and the voltage drop with a large resistance value R increases. For example, when the resistance value R is 1 Q, a voltage drop of 0.2 V occurs when a current of 200 mA flows. As the voltage drop increases, the decrease in the charging voltage to the capacitors 151 and 152 decreases, and thus charging efficiency decreases.

In contrast, in the layout configuration according to the embodiment shown in FIG. 11, as described above, the shortest distance between the first portion 116a of the transistor portion 116 and the pads 201c to 201j is substantially zero, and the shortest distance between the second portion 116b of the transistor portion 116 and the pads 201c to 201j is also substantially zero. Therefore, for example, regarding the PMOS transistor 111, when the shortest distance described above is substantially zero and the longest distance is d3, the resistance value R of the wiring coupling each of the pads 201i and 201j and the PMOS transistor 111 is substantially calculated by Formula (2) using a longest distance d3. In Formula (2), Rp is a sheet resistance value of the wiring, and W is a wiring width.

$$R = \frac{{R}_{p}}{2} ( \frac{d 3}{W} ) \qquad ( 2 )$$

Here, from FIGS. 11 and 14, assuming that the longest distance d3 in the embodiment is about ½ of the longest distance d2 in the comparative example, Formula (2) is transformed into Formula (3).

$$R ≅ \frac{{R}_{p}}{4} ( \frac{d 2}{W} ) \qquad ( 3 )$$

When Formula (1) and Formula (3) are compared, in the layout configuration according to the embodiment, the resistance value R decreases to ½ or less and the voltage drop due to the wiring resistance decreases to ½ or less with respect to a layout configuration of the comparative example.

As described above, in the layout configuration of the embodiment, since the PMOS transistors 111 are disposed adjacent to each other to sandwich the pads 201i and 201j, the wiring coupling the PMOS transistor 111 and the pads 201i and 201j is shortened, and thus the wiring resistance is reduced. As a result, the voltage drop between the PMOS transistor 111 and the CPH terminal corresponding to the pad 201i decreases, and the voltage drop between the PMOS transistor 111 and the VCP terminal corresponding to the pad 201j decreases.

Similarly, since the NMOS transistors 112 are disposed adjacent to each other to sandwich the pads 201g and 201h, the wiring coupling the NMOS transistor 112 and the pads 201g and 201h is shortened, and thus the wiring resistance is reduced. As a result, the voltage drop between the NMOS transistor 112 and the VDD terminal corresponding to the pad 201g decreases, and the voltage drop between the NMOS transistor 112 and the CPH terminal corresponding to the pad 201h decreases.

Similarly, since the PMOS transistors 113 are disposed adjacent to each other to sandwich the pads 201e and 201f, the wiring coupling the PMOS transistor 113 and the pads 201e and 201f is shortened, and thus the wiring resistance is reduced. As a result, the voltage drop between the PMOS transistor 113 and the CPL terminal corresponding to the pad 201e decreases, and the voltage drop between the PMOS transistor 113 and the VDD terminal corresponding to the pad 201f decreases.

Similarly, since the NMOS transistors 114 are disposed adjacent to each other to sandwich the pads 201c and 201d, the wiring coupling the NMOS transistor 114 and the pads 201c and 201d is shortened, and thus the wiring resistance is reduced. As a result, the voltage drop between the NMOS transistor 114 and the VSS terminal corresponding to the pad 201c decreases, and the voltage drop between the NMOS transistor 114 and the CPL terminal corresponding to the pad 201d decreases.

Therefore, according to the arrangement of the transistor portion 116 and the pads 201c to 201j shown in FIG. 11, since the decrease in the charging voltage to the capacitors 151 and 152 is reduced, the charging efficiency is improved, and a desired drive voltage is efficiently generated.

As shown in FIGS. 10 and 11, in a plan view of the semiconductor substrate 200 (a plan view of the integrated circuit device 100), the transistor portion 116, the electrostatic protection circuits 121 to 126, and the pads 201a to 201k are disposed in the region A1 of the corner of the semiconductor substrate 200 (the corner of the integrated circuit device 100). Therefore, the distance between the side 200a and the pads 201a to 201k is relatively short, and the pads 201a to 201k can be coupled to the electrodes provided on the substrate (not shown) on which the integrated circuit device 100 is mounted by bonding wires, and the restriction on a mounting method of the integrated circuit device 100 is small.

The pads 201h and 201i are examples of “first pads”, and the pads 201d and 201e are examples of “second pads”. The pad 201j is another example of the “first pad”, and the pads 201f and 201g are another example of the “second pad”. The Y direction is an example of a “first direction”, and the X direction is an example of a “second direction”.

### 6. Functions and Effects

As described above, in the integrated circuit device 100 according to the embodiment, the first portion 116a and the second portion 116b of the transistor portion 116 that performs charge and discharge control of the capacitors 151 and 152 are disposed with the pads 201c to 201j sandwiched therebetween. The pads 201a to 201k are disposed along the X direction, and the first portion 116a and the second portion 116b are disposed along the Y direction. As a result, a maximum distance between the transistor portions 116 and the pads 201c to 201j is shortened. Further, since neither the electrostatic protection circuits 121 to 126 is disposed between the first portion 116a and the pads 201c to 201j or between the second portion 116b and the pads 201c to 201j, and the first portion 116a and the second portion 116b are disposed adjacent to the pads 201c to 201j, the maximum distance between the transistor portion 116 and the pads 201c to 201j is further shortened. Therefore, since each wiring coupling the transistor portion 116 and the pads 201c to 201j is shortened and the resistance value of each wiring is reduced, the voltage drop generated between the transistor portion 116 and the pads 201c to 201j is reduced. Therefore, according to the integrated circuit device 100 in the embodiment, the decrease in the charging voltage to the capacitors 151 and 152 due to the wiring resistance is reduced, and the charging efficiency of the capacitors 151 and 152 is improved.

As described above, the embodiment or the modification example are described, but the present disclosure is not limited to the embodiment or the modification example, and can be implemented in various forms in a range without departing from the spirit thereof. For example, the above embodiment and the modifications can also be combined as appropriate.

The present disclosure includes substantially the same components as the components explained in the embodiment, for example, components having the same functions, methods, and results or components having the same objects and effects. The present disclosure includes components obtained by replacing non-essential portions of the components explained in the embodiment. The present disclosure includes components that can achieve the same action effects as or components that can achieve the same objects as those of the components explained in the embodiment. The present disclosure includes components obtained by adding a publicly-known technique to the components explained in the embodiment.

The following contents are derived from the embodiment and the modifications explained above.

An aspect of an integrated circuit device includes:
a first pad and a second pad coupled to a capacitor; and
a transistor portion configured to perform charge and discharge control of the capacitor via the first pad and the second pad.

The transistor portion includes a first portion and a second portion disposed with the first pad and the second pad sandwiched therebetween in a plan view.

In the integrated circuit device, since the first portion and the second portion of the transistor portion that performs the charge and discharge control of the capacitor are disposed with the first pad and the second pad sandwiched therebetween, a maximum distance between the transistor portion and the first pad and the second pad is shortened. Therefore, since each wiring which couples the transistor portion and the first pad and the second pad becomes short and a resistance value of each wiring becomes small, the voltage drop which occurs between the transistor portion and the first pad and the second pad becomes small. Therefore, according to the integrated circuit device, it is possible to reduce the decrease in the charging voltage to the capacitor due to the wiring resistance.

In the aspect of the integrated circuit device,

the first portion and the second portion may be disposed adjacent to the first pad and the second pad.

In the integrated circuit device, since the maximum distance between the transistor portion and the first pad and the second pad becomes shorter, each wiring coupling the transistor portion and the first pad and the second pad becomes shorter, and the resistance value of each wiring becomes smaller, and thus the voltage drop occurring between the transistor portion and the first pad and the second pad becomes smaller. Therefore, according to the integrated circuit device, it is possible to further reduce the decrease in the charging voltage to the capacitor due to the wiring resistance.

In the aspect of the integrated circuit device,

the first portion and the second portion may be disposed along a first direction, and the first pad and the second pad may be disposed along a second direction intersecting the first direction.

In the integrated circuit device, since the distance between the first portion of the transistor portion and the first pad and the second pad is shortened and the distance between the second portion of the transistor portion and the first pad and the second pad is also shortened, the voltage drop occurring between the transistor portion and the first pad and the second pad is reduced. Therefore, according to the integrated circuit device, it is possible to further reduce the decrease in the charging voltage to the capacitor due to the wiring resistance.

In the aspect of the integrated circuit device,

the first portion may be disposed between the first pad or the second pad and an electrostatic protection circuit coupled to the first pad or the second pad in a plan view.

In the integrated circuit device, since the distance between the first portion of the transistor portion and the first pad and the second pad is shortened, the voltage drop occurring between the transistor portion and the first pad and the second pad is reduced. Therefore, according to the integrated circuit device, it is possible to further reduce the decrease in the charging voltage to the capacitor due to the wiring resistance.

In the aspect of the integrated circuit device,

the transistor portion may be disposed at a corner of the integrated circuit device in a plan view.

In the integrated circuit device, the first portion or the second portion is disposed between the first pad and the second pad and a side of the integrated circuit device, but since the transistor portion is disposed at the corner of the integrated circuit device, the distance between the side and the first pad and the second pad is relatively small. Therefore, according to the integrated circuit device, the first pad and the second pad can be coupled to an external electrode of the integrated circuit device by a bonding wire, and a restriction of a mounting method is small.

What is claimed is:

1. An integrated circuit device comprising:
a first pad and a second pad coupled to a capacitor; and
a transistor portion configured to perform charge and discharge control of the capacitor via the first pad and the second pad, wherein
the transistor portion includes a first portion and a second portion disposed with the first pad and the second pad sandwiched therebetween in a plan view.

2. The integrated circuit device according to claim 1, wherein
the first portion and the second portion are each disposed adjacent to the first pad and the second pad.

3. The integrated circuit device according to claim 1, wherein
the first portion and the second portion are disposed along a first direction, and the first pad and the second pad are disposed along a second direction intersecting the first direction.

4. The integrated circuit device according to claim 1, wherein
the first portion is disposed between the first pad or the second pad and an electrostatic protection circuit coupled to the first pad or the second pad in a plan view.

5. The integrated circuit device according to claim 1, wherein
the transistor portion is disposed at a corner of the integrated circuit device in a plan view.
